(19) United States
(12) Patent Application Publication
(10) Pub. No.: US 2004/0010577 A1
(43) Pub. Date: Jan. 15, 2004

(54) System and method for optimizing network design in a communications network based on determined network capacity and network utilization

(76) Inventor: Ferit Yegenoglu, Washington, DC (US)

Correspondence Address: WORLDCOM, INC., TECHNOLOGY LAW DEPARTMENT, 1133 19TH STREET NW, WASHINGTON, DC, 20036, US

(21) Appl. No.: 10/190,553

(22) Filed: Jul. 9, 2002

(51) Int. Cl. G06F 15/173

(52) U.S. Cl. 709/223

(57) ABSTRACT

A system and method for optimizing a network design to obtain an optimized network design relative to a desired network capacity. The network design has an initial traffic distribution and is evaluated based on a determined network capacity, network traffic values, and anticipated growth rates bounded by a prescribed growth deviation factor. An optimized traffic matrix is determined using linear programming resources, relative to a maximum capacity for the initial traffic distribution and based on the determined network capacity, the network traffic values, the anticipated growth rates, and the prescribed growth deviation factor. The optimized traffic matrix entry having a minimum growth rate is identified, and link capacity is added based on the entry having the minimum growth rate. The evaluation and capacity addition is repeated for the modified network design until determining that the maximum capacity for the corresponding traffic distribution of the corresponding modified matrix reaches the desired network capacity.

### BACKGROUND OF THE INVENTION

1. Field of the Invention

The present invention relates to network design, and traffic analysis including evaluation of a communications network, for example a broadband communications network.

2. Description of the Related Art

Existing communications networks include nodes and circuits, also referred to as links, that interconnect the nodes. Certain nodes may be configured as source/destination nodes configured for introducing/outputting data traffic to/from the network; hence source/destination nodes are considered to “originate” traffic into the network and “sink” traffic from the network. Other nodes are configured as transit nodes (i.e., intermediate nodes) that only can switch traffic, and cannot originate or sink traffic.

An owner of a large scale communications network, for example a backbone network configured for transporting interexchange carrier traffic or wide area network traffic, sells or leases network resources by offering network access to the communications network in terms of a prescribed data rate, for example a prescribed leased bandwidth or a prescribed leased capacity. The sale or lease of network resources based on a prescribed capacity, for example continuous 10 Gigabit per second (Gbps) capacity, requires that the network owner employ network engineering during network deployment to estimate the data-carrying capacity of the large scale communications network.

Network design capacity typically is estimated during design of the network based on selection of hardware components and circuits having prescribed specifications relative to design criteria. For example, network engineers designing a network for deployment will estimate the network capacity based on prescribed specifications of the hardware components used to implement the nodes, and the bandwidth capacity of the circuits interconnecting the nodes. In particular, hardware components such as ATM switches, Ethernet (IEEE 802.3) switches, frame relay switches, microwave repeaters, satellite ground stations, etc. typically will specify their respective capacities (e.g., 100 Mbps ports, 1 Gbps ports, OC-48 SONET ports, etc.). As the hardware components and circuits are installed, typically the hardware components/circuits and their associated attributes (including network capacity attributes specified in the prescribed specifications) are added to a network inventory database, indicating the installed hardware components are available for network service. The installed hardware components/circuits are then provisioned for network service, enabling the installed hardware components/circuits to service network traffic. Hence, network capacity is affected as hardware components/circuits are added to the network.

The capacity of a large scale communications network in transporting network traffic (i.e., network capacity), however, cannot be precisely determined merely by identifying the prescribed capacity specifications of the installed hardware components. In particular, actual network capacity invariably is less than design estimates due to factors associated with deployment of the network. Determining network capacity becomes substantially complex as the number of circuits and nodes increases in the network, and as network traffic increases. Hence, network owners encounter increasing difficulty in accurately assessing available network capacity for selling or leasing network resources, and for determining whether network expansion is required.

Network planning involves looking at the current network design and the anticipated traffic growth rate between different origination-destination points, and determining where in the network to add more capacity or reduce capacity (in the case of underutilized circuits). Network planning becomes even more difficult, however, when a network planner is unable to precisely identify portions of the network that require more capacity and/or portions of the network that are underutilized. Hence, concerns arise that a modified network design may not adequately match the anticipated future traffic distribution, resulting in an inefficient distribution of capacity within the network that suffers congestion in one portion and underutilized capacity in another portion.

### SUMMARY OF THE INVENTION

There is a need for an arrangement that enables a communications network design to be evaluated in a systematic and accurate manner that enables network capacity design modifications to be implemented according to an anticipated growth pattern with optimum capacity utilization.

There also is a need for an arrangement that enables a new network design to be developed based on selective addition and/or reduction of network capacity according to an anticipated growth pattern, to provide a prescribed traffic network capacity matching a determined maximum network capacity according to a prescribed link utilization threshold.

These and other needs are attained by the present invention, where a system and method for optimizing a network design utilizes a sequence of link capacity modifications to obtain an optimized network design relative to a desired network capacity. The network design has an initial traffic distribution and is evaluated based on a determined network capacity, network traffic values, and anticipated growth rates bounded by a prescribed growth deviation factor. The network design is evaluated by determining an optimized traffic matrix using linear programming resources, relative to a maximum capacity for the initial traffic distribution and based on the determined network capacity, the network traffic values, the anticipated growth rates, and the prescribed growth deviation factor. At least one of the optimized traffic matrix entries is identified as having a minimum growth rate, and the network design is modified by adding link capacity between identified nodes of the network design based on the identified at least one entry having the minimum growth rate. The evaluation is repeated for the modified network design until determining that the maximum capacity for the corresponding traffic distribution of the corresponding modified matrix reaches the desired network capacity.

Hence, a network design can be optimized precisely in a logical, systematic manner, relative to a desired network capacity, by successively evaluating the network design relative to precise capacity, traffic, and growth deviation metrics, changing the network design by adding capacity to identified nodes having minimal growth rates, and evaluating the modified network design to determine whether the desired network capacity has been reached.

One aspect of the present invention provides a method. The method includes evaluating a network design, having an initial traffic distribution that includes initial traffic distribution components between respective source/destination node pairs via network links, by: determining optimized traffic distribution components relative to the respective source/destination node pairs based on determined network link capacity values, the initial traffic distribution components, and identified traffic growth rates of the respective traffic distribution components bounded by a prescribed growth deviation factor; and identifying at least one optimized traffic distribution component as having a minimum traffic growth rate relative to the corresponding initial traffic distribution component. The method also includes adding link capacity to a link between identified nodes, configured for carrying traffic on at least a portion of the at least one optimized traffic distribution component, to generate a modified network design, based on a network capacity for the initial traffic distribution based on the optimized traffic distribution components being less than a desired network capacity. The method also includes determining whether the modified network design has a network capacity for a corresponding traffic distribution that reaches the desired network capacity, based on repeating the evaluating step for the corresponding modified network design. The method also includes selectively repeating the adding of link capacity and the determining of whether the modified network design has a network capacity for a corresponding traffic distribution that reaches the desired network capacity, based on the network capacity for the corresponding traffic distribution being less than the desired network capacity.

An additional feature of this aspect includes identifying from one of the modified network designs at least a second network link having a link utilization less than a desired minimum link utilization, and selectively removing link capacity from the second network link based on the network capacity for the corresponding traffic distribution exceeding the desired network capacity.

Additional advantages and novel features of the invention will be set forth in part in the description which follows and in part will become apparent to those skilled in the art upon examination of the following or may be learned by practice of the invention. The advantages of the present invention may be realized and attained by means of instrumentalities and combinations particularly pointed out in the appended claims.

### BRIEF DESCRIPTION OF THE DRAWINGS

Reference is made to the attached drawings, wherein elements having the same reference numeral designations represent like elements throughout and wherein:

FIGS. 1A, 1B and 1C are diagrams illustrating physical network topology, link capacity, and link traffic, respectively, for a network having nodes and interconnecting links according to a prescribed network topology that can be evaluated according to an embodiment of the present invention.

FIG. 2 is a diagram of a computer-based system configured for optimizing the network of FIG. 1 based on a desired network capacity, desired minimum link utilization, and identified growth rates, according to an embodiment of the present invention.

FIG. 3 is a diagram illustrating a method of evaluating the network of FIG. 1 according to an embodiment of the present invention.

FIG. 4 is a diagram illustrating a second network that can be evaluated and optimized by the system of FIG. 2 according to the method of FIG. 3.

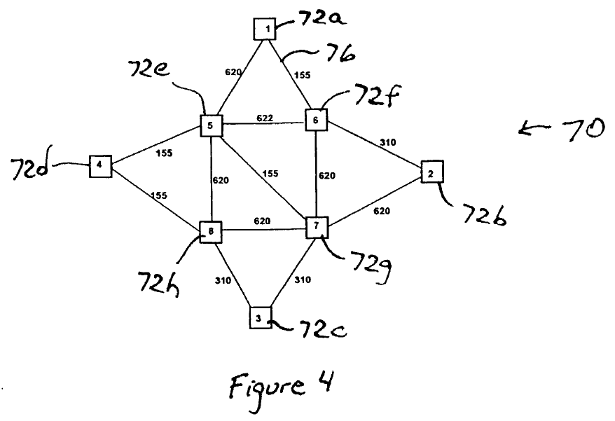

### BEST MODE FOR CARRYING OUT THE INVENTION

The disclosed embodiment is directed to an arrangement for optimizing a network design based on evaluating network attributes based on determined network capacity, utilization, and efficiency attributes relative to different traffic constraints applied to the known network parameters. In particular, the disclosed embodiment provides precise definitions for prescribed metrics used to evaluate a network design. The prescribed metrics, described below, are determined by utilizing commercially available linear programming and mixed integer programming software resources. Once the prescribed metrics have been determined, the network design can be evaluated based on comparing the relative values of the prescribed metrics to determine whether the network design is configured for operating at a desired capacity, whether the capacity is being effectively utilized to accommodate additional traffic growth, and whether the capacity is being utilized efficiently.

Once the network attributes have been evaluated, limitations within the network design can be identified and addressed, for example by adding or removing capacity from a network link, in an effort to resolve the limitations in the network design. The modified network design can then be evaluated to determine whether the modified design satisfies desired capacity and utilization criteria. The process of evaluating a network design, modifying the network design, and evaluating the modified network design can be repeated until the desired network capacity and link utilization parameters have been reached.

Hence, a network design can be systematically evaluated and modified to optimize the network design for existing traffic distribution, expected traffic growth, and efficient link utilization.

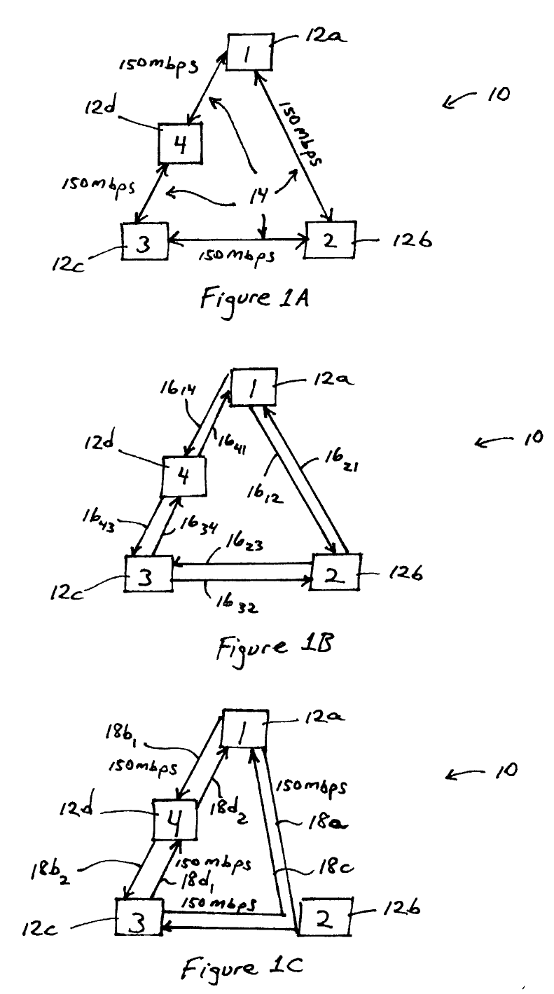

FIGS. 1A, 1B, and 1C are diagrams illustrating different attributes of a network 10 having nodes 12 and links 14 interconnecting the nodes. In particular, FIG. 1A illustrates physical network topology, FIG. 1B illustrates link capacity, and FIG. 1C illustrates link traffic. As illustrated in each of the FIGS. 1A, 1B, and 1C, the network 10 includes nodes 12a, 12b, 12c, and 12d, labeled “1”, “2”, “3”, and “4”, respectively. The nodes 12a, 12b, and 12c are deemed origination/destination nodes that can supply or output network traffic into and out from the network 10, and the node 12d is deemed a transit node (i.e., an intermediate node) configured solely before switching network traffic to another network node.

As illustrated in FIG. 1A the nodes 12 are interconnected by interconnecting links 14, illustrated as two-way links having a two-way bandwidth of 150 Mbps. FIG. 1B illustrates in further detail the link traffic configuration, where each of the interconnecting links are composed of 1-way links 16, each illustrated as having a corresponding link capacity of 150 Mbps. Hence, the bidirectional circuits 14 are modeled herein as two unidirectional links 16.

FIG. 1C illustrates the traffic routing, where all traffic is passed between nodes 12a (“1”) and 12c (“3”). In particular, the traffic routing includes a traffic component18a from node 12a to node 12c via node 12b; a traffic component 18b (composed of legs 18b₁ and 18b₂) from node 12a to node 12c via node 12d; a traffic component18c from node 12c to node 12a via node 12b; and a traffic component 18d (composed of legs 18d₁ and 18d₂) from node 12a to node 12c via node 12d.

According to the disclosed embodiment, network capacity is defined as the maximum volume of traffic that can enter and leave the network, also referred to as the network's maximum throughput. Network capacity also can be measured in bits per second. In particular, the following capacity metrics can be used to specify differing types of capacity within the network 10: absolute capacity (C_{A}) of the network 10, and capacity (C_{T}) for a given traffic distribution 18.

Absolute capacity (C_{A}) is defined as the maximum throughput of the network 10 without any routing constraints or traffic distribution constraints. Hence, the only constraints used for absolute capacity is the maximum link utilization constraints, in other words the capacity of the individual links 16 associated with the nodes 12, discounting transit nodes. As illustrated in FIG. 1B, the absolute capacity (C_{A}) can be determined to equal 900 Mbps (C_{A}=900 Mbps) (after discounting transit node 12d) from the following capacity matrix C that specifies the link capacity Cᵢⱼ for each link 16 configured for sending data from source node i to destination node j:

$$C = [ \begin{matrix}0 & 150 & 0 & 150 \\ 150 & 0 & 150 & 0 \\ 0 & 150 & 0 & 150 \\ 150 & 0 & 150 & 0\end{matrix} ]$$

The problem of determining the absolute network capacity C_{A} is equivalent to finding a traffic matrix T with the largest possible sum of entries Tᵢⱼ. A formal definition that can be used to determine C_{A} using linear programming resources is described in the attached Appendix A.

Capacity for a Given Traffic Distribution (C_{T}) is defined as the maximum throughput of a network 10 for a given traffic distribution, where traffic distribution is defined as the relative size of traffic between different origination/destination pairs. As illustrated in FIG. 1C, the capacity for the given traffic distribution (C_{T}), relative to the traffic components 18, can be determined to equal 600 Mbps (C_{T}=600 Mbps) from the following traffic matrix T that specifies the link traffic Tₖₗ for each link traffic component 18 from source node k to destination node l:

$$T = [ \begin{matrix}0 & 0 & 300 \\ 0 & 0 & 0 \\ 300 & 0 & 0\end{matrix} ]$$

As described below, the objective in calculating C_{T} is to determine how much traffic can grow (based on a maximum growth factor, e.g., αₘₐₓ) while conforming to a given traffic distribution without exceeding maximal allowable utilization on any link. For example, the maximum growth factor for the above traffic matrix T is αₘₐₓ=1 due to the link capacities, indicating no room for growth. However, if the traffic matrix T was substituted with an alternate traffic matrix T2, then the maximum growth factor αₘₐₓ for the alternate traffic matrix T2 may also differ. Hence, if the alternate traffic matrix T2 for the network 10 includes the traffic components:

$$T2 = [ \begin{matrix}0 & 100 & 100 \\ 100 & 0 & 100 \\ 100 & 100 & 0\end{matrix} ] ,$$

where the one-way traffic components between each of the nodes 12a, 12b, and 12c equal 100 Mbps, then the growth factor αₘₐₓ=1.5 based on the capacity matrix C specifying link capacities of 150 Mbps. Hence, the capacity C_{T2} for the traffic distribution T2 would be C_{T2}=900 Mbps. Hence, C_{T} can be determined by:

$${C}_{T} = {\sum }_{i , j}^{} {T}^{′} , where {T}^{′} = {α}_{max} T .$$

A formal definition used to determine C_{T} using linear programming resources is described in the attached Appendix B.

Hence, if the absolute capacity (C_{A}) is greater than the capacity for the given traffic distribution (C_{T}), a network engineer can conclude that the network topology is not a good match for the traffic distribution because C_{T}/C_{A} is substantially less than one (i.e., C_{T} is not substantially equal to C_{A}). In the network 10 illustrated in FIGS. 1A, 1B, and 1C it becomes apparent that the network topology is not a good match to the traffic distribution because all traffic is between nodes 12a (“1”) and 12c (“3”); in fact, the network design can be improved by removing the node 12b (“12”) and adding capacity between the nodes 12a, 12d, and 12c.

Hence, these capacity metrics can be used to determine and evaluate traffic distribution relative to the network topology: if C_{T} is substantially equal to C_{A} such that C_{T}/C_{A}≈1, then there is a good match (i.e., optimization) between the network design and the given traffic distribution; however, if C_{T} is substantially less than C_{A} such that C_{T}/C_{A}<<1, then the network topology is not a good match (i.e., not optimized) for the traffic distribution.

The foregoing discussion of the capacity for a given traffic distribution (C_{T}) is based on a maximum growth rate α_{MAX} that can be applied to each traffic component (Tₖₗ). Each traffic component has its own corresponding growth rate, described below, due to the network topology and associated link capacities; hence, a source/destination node pair in the network design may limit the growth rate for an associated traffic component (Tₖₗ) and hence the maximum growth rate α_{MAX} that can be applied to each traffic component (Tₖₗ). As a result, the capacity for the given traffic distribution (C_{T}) may be substantially less than absolute capacity C_{A} (e.g., C_{T}/C_{A}<<1), such that the network topology is not a good match (i.e., not optimized) for the traffic distribution.

The disclosed embodiment provides an arrangement for improving the network design for the given traffic distribution in a logical sequence of incremental link capacity modifications, based on providing a variable traffic growth rate that enables a computer-based linear programming resource to identify an optimized traffic distribution component (Pₖₗ), within the given traffic distribution, having the minimum traffic growth rate relative to the original traffic distribution component (Tₖₗ)).

Once the optimized traffic distribution component (Pₖₗ) having the minimum traffic growth rate has been identified, indicating the component limiting growth in the network capacity, then the network design may be modified by adding capacity to one or more links for the optimized traffic distribution component (Pₖₗ). The modified network design can then be evaluated by recalculating the capacity attributes C_{A}, C_{T} for the modified network design to determine whether the capacity for the modified traffic distribution C_{T} reaches a desired network capacity C_{MAX}.

As described below, excess capacity can be identified based on link utilization values less than a desired link utilization (γ); the network design can be modified again by removing capacity from the under-utilized links, and recalculating the capacity attributes and link utilization parameters, and successively modifying the network design until the modified network has a capacity (C_{T}) that meets the desired network capacity (C_{MAX}) and all links equal or exceed the desired link utilization (γ).

The optimized traffic distribution component (Pₖₗ) having the minimum traffic growth rate is identified based on utilizing a variable growth rate. In particular, the objective of the linear programming resource is to identify a new (i.e., optimized) traffic matrix P, whose sum of entries (i.e., total traffic volume) is the largest possible under the condition that P is obtained from the initial traffic distribution T in accordance with the anticipated growth rates. Each identified growth rate used during optimization of the optimized traffic distribution component (Pₖₗ) is based on a growth component composed of an anticipated relative growth rate factor (Gₖₗ), a prescribed growth deviation factor (β), and a scalar growth rate (α). Specifically, the following condition must be satisfied:

(1−β)αGₖₗTₖₗ≦Pₖₗ≦(1+β)αGₖₗTₖₗ ∀(k, l=1, . . . , K)

The prescribed growth deviation factor (0<β<1) determines how much the growth pattern can differ from the anticipated traffic growth rate αGₖₗ. Hence, if the prescribed growth deviation factor (β) were equal to zero (β=0), then the traffic would grow exactly in accordance with the anticipated traffic growth rates αGₖₗ. Hence, if prescribed growth deviation factor is greater than zero (β>0), then the actual growth rate for each source/destination node pair (k,l) can deviate slightly from αGₖₗ, i.e., the actual relative growth rates to deviate from the anticipated relative growth rates. Hence, allowing this deviation in the growth factor allows one to determine which source/destination pairs limit the overall traffic growth rate.

Hence, if the growth rate of the optimized traffic distribution component (Pₖₗ) is (1−β)αGₖₗTₖₗ, then capacity should be added in the network between the nodes of the source/destination pairs associated with the corresponding optimized traffic distribution component (Pₖₗ). In other words, maximizing the sum of entries of the matrix P is equivalent to finding the largest possible value of the scalar growth rate (α); since the scalar growth rate (α) is common to all (k,l) pairs, and since the inequality (1−β)αGₖₗTₖₗ≦Pₖₗ must be satisfied for all (k,l) source/destination pairs, the value of the scalar growth rate (α) is limited by the source/destination pairs whose traffic cannot be more than (1−β)αGₖₗTₖₗ.

Hence, the disclosed embodiment enables identification of the source/destination pairs that are limiting overall traffic growth, and that require additional capacity to improve growth.

As described below, the linear programming resources also are used to determine how each optimized traffic distribution component (Pₖₗ) is routed in the network, and the resulting traffic volume (Yᵢⱼ) on each network link (i,j). Hence, link traffic relative to the corresponding link capacity can be compared (Yᵢⱼ/Cᵢⱼ) to a desired minimum link utilization (γ) to identify underutilized links that may have unused capacity removed to improve efficiency. As described below, the desired minimum link utilization (γ) represents the lowest link utilization that can be tolerated.

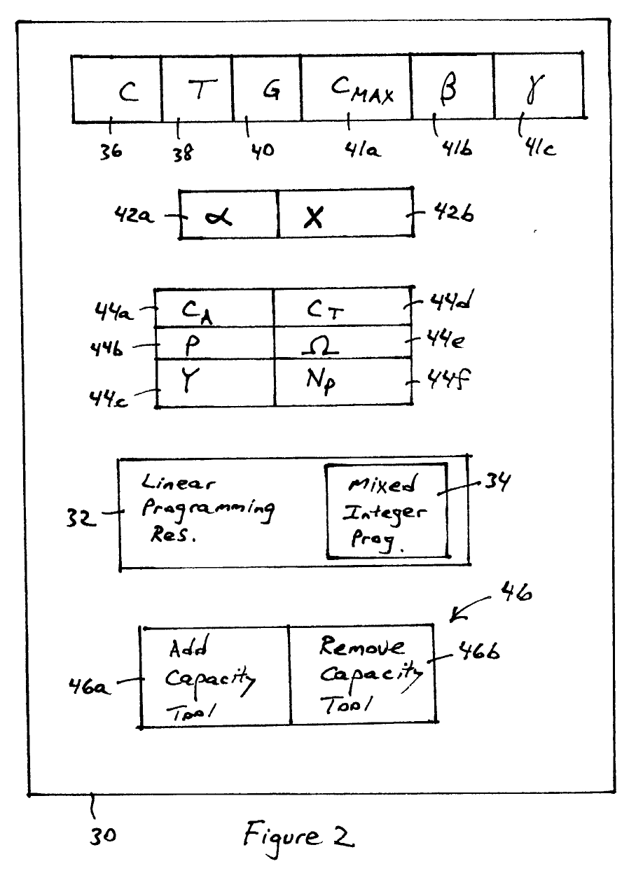

FIG. 2 is a diagram illustrating a computer-based system 30 configured for evaluating the network design 10, and modifying the network design 10 to obtain an optimized network design relative to desired network capacity and desired minimum link utilization, according to an embodiment of the present invention. In particular, the system 30 includes multiple executable resources configured for identifying network attributes, calculating network metrics, and/or evaluating the network attributes and metrics based on linear programming resources. The system 30 also includes design tools enabling a network designer to add or subtract network capacity from network links.

The system 30 includes commercially available linear programming resources 32 including a mixed integer program resource 34. An example of a commercially available linear programming resource 32 is the ILOG Optimization Suite from ILOG, Inc., Mountain View, Calif. The linear programming resources 32 are configured for minimizing a linear objective function of continuous real variables, subject to linear constraints. The mixed integer program resource 34 is utilized to minimize a linear objective function of continuous real variables and binary variables, subject to linear constraints.

As illustrated in FIG. 2, the system 30 is configured for storing network attributes that may be predetermined based on network topology definitions or determined from measurements overtime (e.g., average traffic distribution over one week). In particular, the system 30 includes a capacity resource 36 configured for storing the link capacity matrix C, a traffic resource 38 configured for storing the traffic distribution matrix T, and relative growth resource 40 configured for storing a relative growth matrix G. The system also includes registers configured for storing scalar inputs, such as register 41a configured for storing the desired network capacity (C_{MAX}), register 41b configured for storing the prescribed deviation growth factor (β), and register 41c configured for storing the desired link utilization (γ).

The system 30 also includes resources 42 configured for storing calculated parameters used during linear programming, for example the traffic growth scalar (α) 42a and intermediate routing matrix (X(k,l)) 42b, where the (i,j) element of X(k,l) (i.e., Xᵢⱼ(k,l)) denotes the portion of Pₖₗ carried over link (i,j), described below. Each of the resources configured for storing values may be implemented in software, using software based registers under control of executable code.

The system 30 also includes resources 44 configured for calculating respective network metrics based on applying the linear programming resources 32 or the mixed integer program resource 34. In particular, the resources 44a, 44b, and 44c are configured for calculating absolute capacity (C_{A}), the optimized traffic distribution matrix (P), and the link traffic matrix (Y), respectively. The capacity for a given traffic distribution (C_{T}) is calculated by the resource 44d as a summation of all the traffic distribution components.

The system 30 also includes a minimum growth detector 44e configured for generating an array (Ω) that identifies the set of source/destination pairs (k,l) having the minimum traffic growth rate based on the respective optimized traffic distribution components (Pₖₗ) having a value Pₖₗ=(1−β)αGₖₗTₖₗ. The system 30 also includes a counter 44f configured for counting the number (N_{P}) of source/destination pairs in the array (Ω).

The system 30 also includes a design tool 46 having a capacity addition module 46a and a capacity removal module 46b. The capacity addition module 46a is configured for adding capacity to a selected link between identified nodes 12, for example in prescribed increments of 155 Mbit/s (OC-3). The capacity deletion module 46b is configured for removing capacity from a selected link, for example in the case of underutilized capacity, described below.

Hence, the evaluation processes 44 enable a network engineer to quantitatively determine whether the traffic distribution T is optimized relative to the prescribed network topology, and whether capacity should be added to any one of the network links to improve network capacity in accordance with the desired network capacity (C_{MAX}), or removed from any one of the network links to improve link utilization and efficiency. After the network design has been modified using the design tool 46, the modified network design may be evaluated by the evaluation processes 44, enabling a systematic evaluation of modifications to existing network designs.

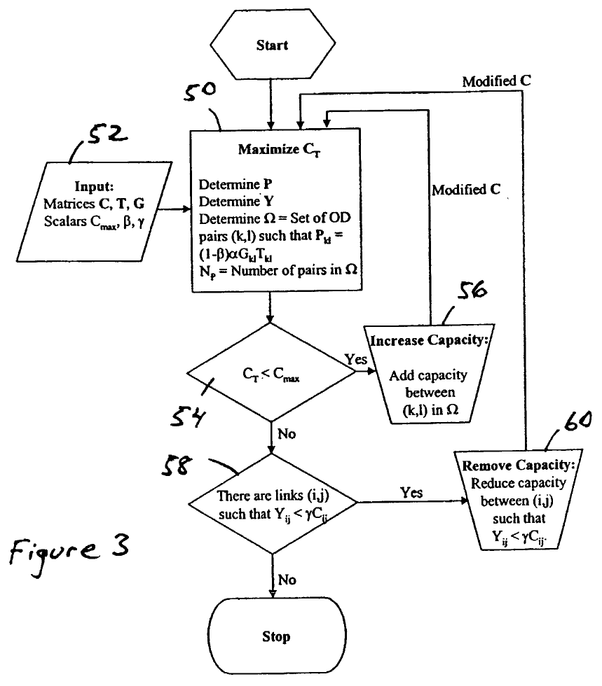

FIG. 3 is a diagram illustrating the method of optimizing a network, according to an embodiment of the present invention. The steps described in FIG. 3 can be implemented as executable code that is stored on a computer readable medium (e.g., a hard disk drive, a floppy drive, a random access memory, a read only memory, an EEPROM, a compact disk, etc), or propagated via a computer readable medium (e.g., a transmission wire, an optical fiber, a wireless transmission medium utilizing an electromagnetic carrier wave, etc.).

The method begins in step 50, where the computer-based system 30 evaluates the network design based on retrieving the inputs in step 52, including the capacity matrix C from the resource 36, the initial traffic distribution matrix T from the resource 38, the relative growth rate factors matrix G from the resource 40, the desired network capacity C_{MAX} from the register 41a, the prescribed growth deviation factor β from the register 41b, and the desired link utilization γ from the register 41c. The capacity matrix C may be stored, for example, by a network engineer during provisioning of the network 10, and the traffic distribution matrix T may be determined, for example, based on traffic measurements over a prescribed time interval (e.g., one week).

The computer-based system 30 calculates in step 50 the optimized traffic distribution matrix P, using the linear programming resource 32, to determine how much traffic can grow while conforming to the given traffic distribution and anticipated traffic growth profile without exceeding link capacity. The sum of the entries of the optimized traffic matrix P is equal to the capacity for the initial traffic distribution (C_{T}). The computer-based system 30 also determines the link utilization matrix Y, representing, for each link (i,j), the sum of traffic components sent between origination/destination pairs (k,l).

The computer-based system 50 also identifies in step 50, during execution of the linear programming resource 32, the origination-destination node pairs (k,l) that need more capacity between the two nodes, based on the corresponding optimized traffic distribution component (Pₖₗ) having a minimum traffic growth rate ((1−β)αGₖₗ) relative to the corresponding initial traffic distribution component (Tₖₗ): Pₖₗ=(1−β)αGₖₗTₖₗ. The identified origination/destination node pairs (k,l) that need more capacity are stored in step 50 in the register 44e as an array (Ω), and the number of origination/destination node pairs (N_{P}) are stored in the register 44f. A formal definition used to determine the scaled traffic matrix P, the link utilization matrix Y, and the capacity for the corresponding traffic distribution C_{T} using linear programming resources is described in the attached Appendix C.

If in step 54 the computer-based system 30 determines that the network capacity for the corresponding traffic distribution (C_{T}) is less than the desired network capacity (C_{MAX}), then link capacity is added in step 56 using the add capacity design tool resource 46a. Note that a direct link does not need to necessarily be added between the two nodes, i.e. between node k and node l; rather, capacity is added to an existing link in the network that allows more traffic to flow from node k to node l. Note that the value of N_{P} (i.e., the size of Ω) is based on the prescribed growth deviation factor (β): a smaller deviation causes the size of the array Ω to be smaller, and a larger deviation causes the size of Ω to be larger.

After the network design has been modified with the added capacity, the evaluation step 50 is repeated for the modified network design. Hence, successive iterations of evaluating the network design in step 50, and adding capacity in step 56 may occur until the network capacity for the corresponding traffic distribution (C_{T}) reaches the desired network capacity (C_{MAX}).

If in step 54 the desired network capacity has been reached, the computer-based system 30 determines in step 58 whether any underutilized links exist such that the total traffic over the link (Yᵢⱼ) is less than the link capacity (Cᵢⱼ) relative to the desired link utilization (γ):

Yᵢⱼ<γCᵢⱼ or Yᵢⱼ/Cᵢⱼ<γ

If in step 58 the computer-based system 30 detects the presence of underutilized links, the computer-based system 30 removes capacity in step 60 from the underutilized links using the capacity removal tool 46b.

In this disclosure, for the purpose of generality, it is assumed that links are unidirectional, and that capacity can be added to or subtracted from the two unidirectional links between any two nodes independently. Further, for generality, it is assumed that link capacity is continuous and the added/subtracted value is unrestricted. In actual implementations, however, adding capacity or removing capacity is typically achieved by adding or removing physical circuits. Physical circuits are bi-directional and can have only certain prescribed capacity values (e.g. 155 Mbit/s for an OC3 circuit, 622 Mbit/s for an OC12 circuit). When this is the case, capacity can only be added/removed in both unidirectional links between any two nodes, and the capacity value can only be selected among the set of valid circuit capacity values. When adding capacity between nodes i and j, both Cᵢⱼ and Cⱼᵢ must be increased by the same amount. Conversely, when identifying a low-utilized link, preference must be given to the cases where both Yᵢⱼ/Cᵢⱼ and Yⱼᵢ/Cⱼᵢ are less than the desired link utilization (γ). This is a special case of the general approach presented here.

After the network design has been modified with the reduced capacity, the evaluation step 50 is repeated for the modified network design. Hence, successive iterations of evaluating the network design in step 50, and reducing capacity in step 60 may occur until each of the network links has a link utilization (Yᵢⱼ/Cᵢⱼ) at least equal to the desired link utilization (γ).

FIG. 5 is a diagram illustrating a network design 70 that can be optimized based on the method of FIG. 3, according to an embodiment of the present invention. The network design 70 includes origination/destination nodes 72a, 72b, 72c, and 72d, and intermediate nodes 72e, 72f, 72g, and 72h. Each of the nodes 72 are interconnected by links 76 having prescribed capacity values according to the following capacity matrix C (in units of Mbit/s), and the traffic matrix T (in units of Mbit/s):

$$C = [ \begin{matrix}0 & 0 & 0 & 0 & 620 & 155 & 0 & 0 \\ 0 & 0 & 0 & 0 & 0 & 310 & 620 & 0 \\ 0 & 0 & 0 & 0 & 0 & 0 & 310 & 310 \\ 0 & 0 & 0 & 0 & 155 & 0 & 0 & 155 \\ 620 & 0 & 0 & 155 & 0 & 620 & 155 & 155 \\ 155 & 310 & 0 & 0 & 620 & 0 & 620 & 0 \\ 0 & 620 & 310 & 0 & 155 & 620 & 0 & 620 \\ 0 & 0 & 310 & 155 & 620 & 0 & 620 & 0\end{matrix} ]$$

$$T = [ \begin{matrix}0 & 50 & 100 & 50 \\ 50 & 0 & 25 & 25 \\ 50 & 25 & 0 & 25 \\ 50 & 25 & 25 & 0\end{matrix} ]$$

The anticipated traffic growth rate is assumed to be identical between all origination/destination nodes, therefore the growth rate matrix is given as:

$$G = [ \begin{matrix}1 & 1 & 1 & 1 \\ 1 & 1 & 1 & 1 \\ 1 & 1 & 1 & 1 \\ 1 & 1 & 1 & 1\end{matrix} ]$$

the desired network capacity (C_{MAX}) is assumed to be 2200 Mbit/s, the prescribed growth deviation factor (β) is set at 0.1, and the minimum desired link utilization (γ) is set at 0.5.

Iteration 1: Upon executing the linear programming resource 32 for the network design illustrated in FIG. 5 according to the linear programming formulations specified in the attached Appendix C for execution of step 50, the obtained capacity for the initial traffic distribution (C_{T}) is calculated to equal 1756 Mbit/s, the scalar growth factor (α) is calculated to equal 3.44, and the array (Ω) includes the set of source/destination pairs having minimum traffic growth rates:

Ω={(1,4), (2,4), (3,4), (4,1), (4,2), (4,3)}.

Since C_{T} is less than C_{MAX}, network capacity is increased in step 56 based on the set of source/destination pairs identified by Ω: in this case, capacity is added to/from node “4” 72d by adding an additional OC-3 circuit (155 Mbit/s) to the links (4,8) and (8,4) and modifying C₄₈ and C₈₄ of the capacity matrix C to equal 310 Mbit/s.

Iteration 2: The modified network design is then evaluated in step 50, and on this iteration the obtained capacity for the initial traffic distribution (C_{T}) is calculated to equal 2188 Mbit/s, the scalar growth factor (α) is calculated to equal 4.3, and the array (Ω) includes the set of source/destination pairs having minimum traffic growth rates:

Ω={(1,2), (1,3), (1,4)}.

Since C_{T} is still less than C_{MAX}, network capacity is increased in step 56 based on the set of source/destination pairs identified by Ω: in this case, capacity is added to/from node “1” 72a by adding an additional OC-3 circuit (155 Mbit/s) to the links (1,6) and (6,1) and modifying C₁₆ and C₆₁ of the capacity matrix C to equal 310 Mbit/s.

Iteration 3: After increasing the capacity to/from node “1”, the modified network design is evaluated in step 50, and on this iteration the obtained capacity for the initial traffic distribution (C_{T}) is calculated to equal 2332 Mbit/s, the scalar growth factor (α) is calculated to equal 4.6, and the array (Ω) includes the set of source/destination pairs having minimum traffic growth rates:

Ω={(2,3), (3,4), (4,3)}.

Since C_{T} is now greater than C_{MAX}, network capacity can be reduced in step 60 based on identifying link utilizations less than the desired link utilization (γ=0.5). A review of exemplary link utilizations determined during the current iteration of the network design evaluation in step 50 indicates that links (7,8) and (8,7) have a relatively low utilizations of 0.0 and 0.25, respectively:

Y[1,5]/C[1,5]=0.9814

Y[1,6]/C[1,6]=1.0000

Y[2,6]/C[2,6]=0.3550

Y[2,7]/C[2,7]=0.5740

Y[3,7]/C[3,7]=1.0000

Y[3,8]/C[3,8]=0.5555

Y[4,5]/C[4,5]=1.0000

Y[4,8]/C[4,8]=1.0000

Y[5,1]/C[5,1]=0.6960

Y[5,4]/C[5,4]=1.0000

Y[5,6]/C[5,6]=0.3224

. . .

Y[6,2]/C[6,2]=0.0000

. . .

Y[7,8]/C[7,8]=0.0000

. . .

Y[8,7]/C[8,7]=0.2500

Note that other links also illustrate relatively low link utilizations, and the disclosed examples for increasing or decreasing capacity are by way of illustration only. Hence, all the 620 Mbit/s capacity in each of the links (7,8) and (8,7) is removed in step 60 by setting the capacity values C₇₈=C₈₇=0.

Iteration 4: The modified network design is evaluated in step 50, and on this iteration the obtained capacity for the initial traffic distribution (C_{T}) is calculated to again equal 2332 Mbit/s, the scalar growth factor (α) is calculated to again equal 4.6, and the array (Ω) includes the set of source/destination pairs having minimum traffic growth rates:

Ω={(2,3), (2,4), (4,3)}.

Since C_{T} is still greater than C_{MAX}, network capacity can be reduced in step 60 based on identifying link utilizations less than the desired link utilization (γ=0.5). In this iteration, links (5,6) and (6,5) are found to have very low utilizations 0.25 and 0.17, respectively; hence, the capacity is reduced by 465 Mbit/s in these links by setting the capacity values

C₅₆=C₆₅=620−465=155 Mbit/s.

Iteration 5: The modified network design is evaluated in step 50, and on this iteration the obtained capacity for the initial traffic distribution (C_{T}) is calculated to again equal 2332 Mbit/s, the scalar growth factor (α) is calculated to again equal 4.6, and the array (Ω) includes the set of source/destination pairs having minimum traffic growth rates:

Ω={(1,3), (2,3), (4,3)}.

Since C_{T} is still greater than than C_{MAX}, network capacity can be reduced in step 60 based on identifying link utilizations less than the desired link utilization (γ=0.5). In this iteration, links (6,7) and (7,6) are found to have low utilizations 0.49 and 0.54, respectively; hence, the capacity is reduced by 465 Mbit/s in these links by setting the capacity values

C₆₇=C₇₆=620−465=155 Mbit/s.

Iteration 6: The modified network design is evaluated in step 50, and on this iteration the obtained capacity for the initial traffic distribution (C_{T}) is calculated to again equal 2332 Mbit/s, the scalar growth factor (α) is calculated to again equal 4.6, and the array (Ω) includes the set of source/destination pairs having minimum traffic growth rates:

Ω={(2,3), (4,3)}.

Since C_{T} is still greater than C_{MAX}, network capacity can be reduced in step 60 based on identifying link utilizations less than the desired link utilization (γ=0.5). In this iteration, link (6,5) has zero utilization; hence the remaining capacity of 155 Mbit/s is removed by setting the capacity value to zero (C₆₅=0).

Iteration 7: The modified network design is evaluated in step 50, and on this iteration the obtained capacity for the initial traffic distribution (C_{T}) is calculated to again equal 2332 Mbit/s, the scalar growth factor (α) is calculated to again equal 4.6, and the array (Ω) includes the set of source/destination pairs having minimum traffic growth rates:

Ω={(2,3), (4,3)}.

Since C_{T} is still greater than C_{MAX}, network capacity can be reduced in step 60 based on identifying link utilizations less than the desired link utilization (γ=0.5). In this iteration, link (7,6) has zero utilization; hence, the remaining capacity of 155 Mbit/s is removed by setting the capacity value to zero (C₇₆=0).

Iteration 8: The modified network design is evaluated in step 50, and on this iteration the obtained capacity for the initial traffic distribution (C_{T}) is calculated to again equal 2332 Mbit/s, the scalar growth factor (α) is calculated to again equal 4.6, and the array (Ω) includes the set of source/destination pairs having minimum traffic growth rates:

Ω={(2,3), (4,3)}.

Since C_{T} is still greater than C_{MAX}, network capacity can be reduced in step 60 based on identifying link utilizations less than the desired link utilization (γ=0.5). In this iteration, it is determined that each of the links (i,j) have a link utilization Y[i,j]/C[i,j] of at least the desired link utilization (γ=0.5), resulting in a modified network design that can deliver 2332 Mbit/s of throughput without wasting link capacity. The resulting network design is given by the final capacity matrix C:

$$C = [ \begin{matrix}0 & 0 & 0 & 0 & 620 & 310 & 0 & 0 \\ 0 & 0 & 0 & 0 & 0 & 310 & 620 & 0 \\ 0 & 0 & 0 & 0 & 0 & 0 & 310 & 310 \\ 0 & 0 & 0 & 0 & 155 & 0 & 0 & 310 \\ 620 & 0 & 0 & 155 & 0 & 155 & 155 & 155 \\ 310 & 310 & 0 & 0 & 0 & 0 & 155 & 0 \\ 0 & 620 & 310 & 0 & 155 & 0 & 0 & 0 \\ 0 & 0 & 310 & 310 & 620 & 0 & 0 & 0\end{matrix} ]$$

The sum of the link capacities in the final modified network is 7285 Mbit/s. The sum of the link capacities in the initial network, illustrated in FIG. 5, is 10,075 Mbit/s. However, the revised network can deliver 2332 Mbit/s, whereas the original network could deliver only 1757 Mbit/s of traffic, assuming the traffic grows as anticipated (i.e., uniformly).

According to the disclosed embodiment, network traffic and performance can be precisely analyzed based on systematic definitions of capacity, utilization, and efficiency metrics under different constraints. The establishment of recognized metrics enables systematic analysis and modification for any network, enabling successive optimization of a network in a logical, consistent manner to maximize network capacity and minimize underutilized resources. The disclosed methodology can be applied to different network technologies, including Internet Protocol networks, ATM networks, frame relay networks, etc.

While this invention has been described in connection with what is presently considered to be the most practical and preferred embodiment, it is to be understood that the invention is not limited to the disclosed embodiments, but, on the contrary, is intended to cover various modifications and equivalent arrangements included within the spirit and scope of the appended claims.

What is claimed is:

1. A method comprising:
evaluating a network design, having an initial traffic distribution that includes initial traffic distribution components between respective source/destination node pairs via network links, by:
determining optimized traffic distribution components relative to the respective source/destination node pairs based on determined network link capacity values, the initial traffic distribution components, and identified traffic growth rates of the respective traffic distribution components bounded by a prescribed growth deviation factor, and
identifying at least one optimized traffic distribution component as having a minimum traffic growth rate relative to the corresponding initial traffic distribution component;
adding link capacity to a link between identified nodes, configured for carrying traffic on at least a portion of the at least one optimized traffic distribution component, to generate a modified network design, based on a network capacity for the initial traffic distribution based on the optimized traffic distribution components being less than a desired network capacity;
determining whether the modified network design has a network capacity for a corresponding traffic distribution that reaches the desired network capacity, based on repeating the evaluating step for the corresponding modified network design; and
selectively repeating the adding of link capacity and the determining of whether the modified network design has a network capacity for a corresponding traffic distribution that reaches the desired network capacity, based on the network capacity for the corresponding traffic distribution being less than the desired network capacity.

2. The method of claim 1, further comprising:
identifying from one of the modified network designs at least a second network link having a link utilization less than a desired minimum link utilization; and
selectively removing link capacity from the second network link based on the network capacity for the corresponding traffic distribution exceeding the desired network capacity.

3. The method of claim 2, further comprising repeating identifying at least a second network link having a link utilization less than a desired minimum link utilization, and selectively removing link capacity from the second network link, until each of the network links has a link utilization at least equal to the desired link utilization.

4. The method of claim 2, wherein the identifying at least a second network link having a link utilization less than a desired minimum link utilization includes determining, for each network link, the corresponding link utilization based on a corresponding total link traffic relative to a corresponding link capacity.

5. The method of claim 4, wherein the determining optimized traffic distribution components includes executing an executable linear programming resource to obtain the optimized traffic distribution components, the identified traffic growth rates, and the total link traffic for each of the network links.

6. The method of claim 1, wherein determining optimized traffic distribution components includes determining the optimized traffic distribution components further based on identifying the identified traffic growth rates relative to prescribed anticipated relative growth rate factors for the respective initial traffic distribution components.

7. The method of claim 6, wherein the evaluating the network design further includes determining the network capacity for the corresponding traffic distribution based on the determined network link capacity values and the corresponding traffic distribution components between the respective origination/destination nodes, the network capacity for the corresponding traffic distribution identifying a maximum traffic volume that can be carried by the network according to the corresponding network design and the corresponding traffic.

8. The method of claim 7, wherein the evaluating the network design includes executing an executable linear programming resource to obtain the optimized traffic distribution components, and the identified traffic growth rates.

9. A system including:
means for evaluating a network design, having an initial traffic distribution that includes initial traffic distribution components between respective source/destination node pairs via network links, the evaluating means configured for:
determining optimized traffic distribution components relative to the respective source/destination node pairs based on determined network link capacity values, the initial traffic distribution components, and identified traffic growth rates of the respective traffic distribution components bounded by a prescribed growth deviation factor, and
identifying at least one optimized traffic distribution component as having a minimum traffic growth rate relative to the corresponding initial traffic distribution component;
means for adding link capacity to a link between identified nodes, configured for carrying traffic on at least a portion of the at least one optimized traffic distribution component, to generate a modified network design, based on a network capacity for the initial traffic distribution based on the optimized traffic distribution components being less than a desired network capacity;
the evaluating means configured for determining whether the modified network design has a network capacity for a corresponding traffic distribution that reaches the desired network capacity, based on repeating the evaluation for the corresponding modified network design, and the adding means and the evaluating means each configured for selectively repeating the respective adding link capacity and the determining of whether the modified network design has a corresponding network capacity for the corresponding traffic distribution that reaches the desired network capacity, for successive modified network designs based on the network capacity for each corresponding traffic distribution being less than the desired network capacity.

10. The system of claim 9, further comprising:
means for identifying from one of the modified network designs at least a second network link having a link utilization less than a desired minimum link utilization; and
means for selectively removing link capacity from the second network link based on the network capacity for the corresponding traffic distribution exceeding the desired network capacity.

11. The system of claim 10, wherein the means for identifying at least a second network link and the selectively removing means each are configured for repeating the second identifying and the selective removing, respectively, for the successive modified network designs until each of the network links has a link utilization at least equal to the desired link utilization.

12. The system of claim 10, wherein the means for identifying at least a second network link is configured for determining, for each network link, the corresponding link utilization based on a corresponding total link traffic relative to a corresponding link capacity.

13. The system of claim 12, wherein the means for evaluating a network design is configured for executing an executable linear programming resource to obtain the optimized traffic distribution components, the identified traffic growth rates, and the total link traffic for each of the network links.

14. The system of claim 9, wherein the means for evaluating a network design is configured for determining the optimized traffic distribution components further based on identifying the identified traffic growth rates relative to prescribed anticipated relative growth rate factors for the respective initial traffic distribution components.

15. The system of claim 14, wherein the means for evaluating a network design further is configured for determining the network capacity for the corresponding traffic distribution based on the determined network link capacity values and the corresponding traffic distribution components between the respective origination/destination nodes, the network capacity for the corresponding traffic distribution identifying a maximum traffic volume that can be carried by the network according to the corresponding network design and the corresponding traffic distribution.

16. The system of claim 15, wherein the means for evaluating a network design is configured for executing an executable linear programming resource to obtain the optimized traffic distribution components, and the identified traffic growth rates.

17. A computer readable medium having stored thereon sequences of instructions for evaluating a network design, the sequences of instructions including instructions for performing the steps of:
evaluating a network design, having an initial traffic distribution that includes initial traffic distribution components between respective source/destination node pairs via network links, by:
determining optimized traffic distribution components relative to the respective source/destination node pairs based on determined network link capacity values, the initial traffic distribution components, and identified traffic growth rates of the respective traffic distribution components bounded by a prescribed growth deviation factor, and
identifying at least one optimized traffic distribution component as having a minimum traffic growth rate relative to the corresponding initial traffic distribution component;
adding link capacity to a link between identified nodes, configured for carrying traffic on at least a portion of the at least one optimized traffic distribution component, to generate a modified network design, based on a network capacity for the initial traffic distribution based on the optimized traffic distribution components being less than a desired network capacity;
determining whether the modified network design has a network capacity for a corresponding traffic distribution that reaches the desired network capacity, based on repeating the evaluating step for the corresponding modified network design; and
selectively repeating the adding of link capacity and the determining of whether the modified network design has a network capacity for a corresponding traffic distribution that reaches the desired network capacity, based on the network capacity for the corresponding traffic distribution being less than the desired network capacity.

18. The medium of claim 17, further comprising instructions for performing the steps of:
identifying from one of the modified network designs at least a second network link having a link utilization less than a desired minimum link utilization; and
selectively removing link capacity from the second network link based on the network capacity for the corresponding traffic distribution exceeding the desired network capacity.

19. The medium of claim 18, further comprising instructions for performing the step of repeating identifying at least a second network link having a link utilization less than a desired minimum link utilization, and selectively removing link capacity from the second network link, until each of the network links has a link utilization at least equal to the desired link utilization.

20. The medium of claim 18, wherein the identifying at least a second network link having a link utilization less than a desired minimum link utilization includes determining, for each network link, the corresponding link utilization based on a corresponding total link traffic relative to a corresponding link capacity.

21. The medium of claim 20, wherein the determining optimized traffic distribution components includes executing an executable linear programming resource to obtain the optimized traffic distribution components, the identified traffic growth rates, and the total link traffic for each of the network links.

22. The medium of claim 17, wherein the determining optimized traffic distribution components includes determining the optimized traffic distribution components further based on identifying the identified traffic growth rates relative to prescribed anticipated relative growth rate factors for the respective initial traffic distribution components.

23. The medium of claim 22, wherein the evaluating the network design further includes determining the network capacity for the corresponding traffic distribution based on the determined network link capacity values and the corresponding traffic distribution components between the respective origination/destination nodes, the network capacity for the corresponding traffic distribution identifying a maximum traffic volume that can be carried by the network according to the corresponding network design and the corresponding traffic.

24. The medium of claim 23, wherein the evaluating the network design includes executing an executable linear programming resource to obtain the optimized traffic distribution components, and the identified traffic growth rates.
